(19) United States
(12) Patent Application Publication
(10) Pub. No.: US 2009/0155552 A1
(43) Pub. Date: Jun. 18, 2009

(54) IC CHIP PACKAGE SUBSTRATE HAVING OUTERMOST GLASS FIBER REINFORCED EPOXY LAYERS AND RELATED METHOD

(75) Inventors: Edmund Blackshear, Wappingers Falls, NY (US); Kevin A. Dore, Fishkill, NY (US)

Correspondence Address: HOFFMAN WARNICK LLC, 75 STATE ST, 14TH FL, ALBANY, NY, 12207, US

(73) Assignee: INTERNATIONAL BUSINESS MACHINES CORPORATION, Armonk, NY (US)

(21) Appl. No.: 11/956,619

(22) Filed: Dec. 14, 2007

(51) Int. Cl. B32B 3/10; B32B 37/12

(52) U.S. Cl. 428/209; 156/60

(57) ABSTRACT

An IC chip package having a glass reinforced outermost epoxy layers and related method are disclosed. In one embodiment, the IC chip package includes an IC chip; and a substrate coupled to the IC chip, the substrate including a glass fiber reinforced epoxy core, a plurality copper circuitry containing, particle reinforced epoxy layers symmetrically-oriented to each surface of the glass fiber reinforced epoxy core, and an outermost glass fiber reinforced epoxy layer on each surface of the plurality of layers, wherein the IC chip is coupled to copper circuitry bonded to one of the outermost glass fiber reinforced epoxy layer.

### BACKGROUND

1. Technical Field

The disclosure relates generally to IC chip packages, and more particularly, to an IC chip package having outermost glass fiber reinforced epoxy layers.

2. Background Art

Flip chip integrated circuit (IC) packages that use sequential build up laminate substrates are susceptible to a number of problems. First, warping both overall and locally at the flip chip mounting site can cause yield losses at fabrication and assembly, as well as quality and reliability problems in use. The typical approach to manage warping has been to use a thicker or multilayer glass fiber reinforced core in the center of the laminate and carefully manage the balance and symmetry for each material type across all axes in all layers of the package. For example, a fiberglass reinforced core of approximately 400 microns thickness with approximately 400 microns of epoxy and copper sequential build up laminate on either side has been used with the expectation of good warping performance. Unfortunately, the warp performance of this structure leaves room for improvement. Second, coefficient of thermal expansion (CTE) mismatch between substrate and silicon IC chip causes mechanical stresses of a magnitude that leads to reliability issues. One approach to address this problem has been to add low expansion particle filler to the laminate layers. Further control of the CTE mismatch may be attained by careful selection of base dielectric resins for reduced CTE differential. A third problem is resin cracking in the sequential build up laminate substrate where regions of the laminate are un-reinforced by metal vertically through the laminate layers. For example, resin rich areas, which may be reinforced with, for example, silica particles, are prone to dielectric cracking at the edge of copper features. One approach to address this issue is to overlap copper areas in adjacent layers, providing mechanical and electrical coupling. While the mechanical coupling is favorable, the electrical coupling is unfavorable because it adds capacitance.

### SUMMARY

An IC chip package having a glass reinforced outermost epoxy layers and related method are disclosed. In one embodiment, the IC chip package includes an IC chip; and a substrate coupled to the IC chip, the substrate including a glass fiber reinforced epoxy core, a plurality of copper circuitry containing particle reinforced epoxy layers symmetrically-oriented to each surface of the glass fiber reinforced epoxy core, and an outermost glass fiber reinforced epoxy layer on each surface of the plurality of layers, wherein the IC chip is coupled to copper circuitry bonded to one of the outermost glass fiber reinforced epoxy layer.

A first aspect of the disclosure provides a method comprising: forming a glass fiber reinforced epoxy core; forming a plurality of copper circuitry containing particle reinforced epoxy layers symmetrically to each surface of the glass fiber reinforced epoxy core; forming an outermost glass fiber reinforced epoxy layer on each surface of the plurality of layers; and mounting an IC chip to copper circuitry bonded to one of the outermost glass fiber reinforced epoxy layers.

A second aspect of the disclosure provides an integrated circuit (IC) chip package comprising: an IC chip; and a substrate coupled to the IC chip, the substrate including a glass fiber reinforced epoxy core, a plurality copper circuitry containing, particle reinforced epoxy layers symmetrically-oriented to each surface of the glass fiber reinforced epoxy core, and an outermost glass fiber reinforced epoxy layer on each surface of the plurality of layers, wherein the IC chip is coupled to copper circuitry bonded to one of the outermost glass fiber reinforced epoxy layer.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a cross-sectional view of one embodiment of an IC chip package according to the disclosure.

FIG. 2 shows a cross-sectional view of another embodiment of an IC chip package according to the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

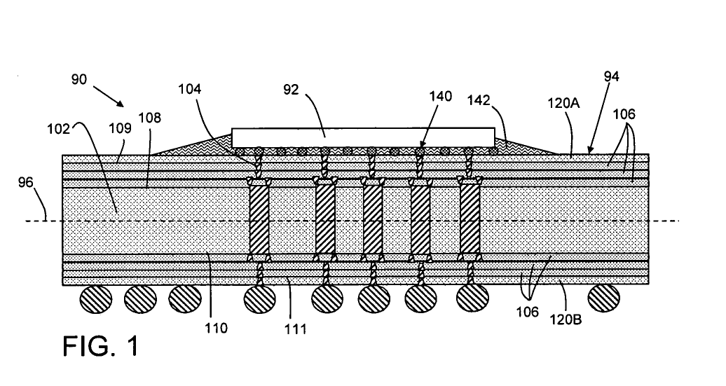

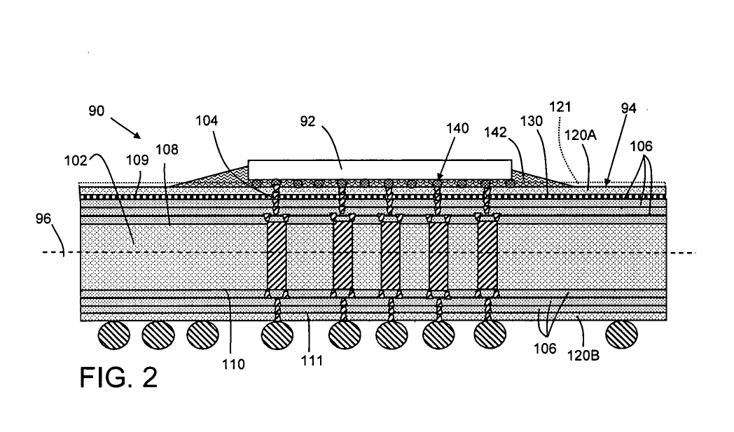

Referring to FIG. 1, a cross-sectional view of one embodiment of an IC chip package 90 according to the disclosure is illustrated. IC chip package 90 includes an IC chip 92, and a substrate 94 coupled to IC chip 92. Substrate 94 includes a glass fiber reinforced epoxy core 102, a plurality of copper circuitry 104 containing, particle reinforced epoxy layers 106 symmetrically-oriented to each surface 108, 110 of core 102, and an outermost glass fiber reinforced epoxy (prepreg) layer 120A, 120B on each surface 109, 111 of the plurality of layers 106. Alternatively, a finish coat 121 (in phantom in FIG. 2) may be provided above one of glass reinforced epoxy layer 120A. In this case, finish coat 121 is patterned to provide access to circuitry 140 through holes in finish coat 121.

IC chip 92 is coupled to copper circuitry 140 bonded to one of outermost glass fiber reinforced epoxy layers 120A (hereinafter “chip-side outermost layer 120A”) on one side. Outermost layers 120A, 120B may have a thickness of approximately 15 to 50 micrometers (μm) such that they are thin enough that they can be laser drilled for microvias at the dimensions required by the flip chip footprint. Outermost layers 120A, 120B may have a coefficient of thermal expansion (CTE) of approximately 16 to 18 parts per million per degree Celsius (ppm/° C.) below a glass transition temperature of an epoxy matrix of glass fiber reinforced epoxy core 102, and 8-16 ppm/° C. above the glass transition temperature of the epoxy matrix. This CTE is in contrast to conventional outermost layers of IC chip packages, which typically include one of layers 106 and have a CTE of approximately 40 ppm/° C. below the glass transition temperature of the epoxy matrix, and approximately 120 ppm/° C. above, which allows for warping, cracking and reliability issues. IC chip 92 may have a CTE of approximately 3 ppm/° C., thus the difference in CTE between substrate 92, i.e., at chip-side outermost layer 120A, and IC chip 92 is decreased compared to IC chip package substrates of conventional construction. In addition, outermost layers 120A, 120B offer increased stiffness and/or warping reduction. Conventional models may mandate that the contribution of the improved mechanical properties of the glass fibers to the bending resistance of the substrate be proportional to the cube of the distance of one of outermost layers 120A, 120B to substrate 94 center plane 96. Using the fiber reinforced material as outermost layers 120A, 120B also offers greater reduction in CTE in the direction parallel to surface 108 of substrate 92 and the area closest to the fragile chip surface than that offered by increased filler particle loadings or resin modification, and solves the resin cracking issue by providing reinforcement in resin rich areas (typically in the areas in the laminate surrounding vias above ball grid array (BGA) pads 140).

According to an embodiment of a method according to the disclosure, glass fiber reinforced epoxy core 102 is formed using any now known or later developed process. Core 102 may include a commercially available material such as: those from the family of materials by Hitachi chemical designated E-679, Matsushita electronic materials designated R1515, and similar materials available from most printed circuit board reinforced laminate material suppliers. A plurality of copper circuitry 104 containing, particle reinforced epoxy layers 106 are then formed symmetrically to each surface 108, 110 of core 102. This process may also include using any now known or later developed process such as sequential lamination, co-lamination, with metallurgy deposited by semi-additive plating, circuitized by a subtractive process, or formed by a dual damascene process. Layers 106 may include a material such as: Ajinimoto GX series material, or similar material from such suppliers as Hitachi Chemical, Sumitomo electronic materials, etc., each of which may include, for example, silica particles. Layers 106 have CTE ranging from approximately 27 to 50 ppm/° C.

Outermost glass fiber reinforced epoxy layers 120A, 120B are then formed on a surface (109, 111 as shown) of layers 106. Outermost layers 120A, 120B may include any of the materials listed for core 102, as well as those listed for build up layers when reinforced by glass cloth. This formation process may include, in one embodiment, laminating outermost layers 120A, 120B to layers 106 using pressure and thermal curing. Alternatively, as shown in FIG. 2, this process may include pre-curing outermost layer(s) 120A, 120B (i.e., away from layers 106) and bonding outermost layer(s) 120A, 120B to layers 106 using pressure, heat and an adhesive layer 130. Adhesive layer 130 may include, for example, particle filled epoxy build up materials such as those listed herein for build up layers

Finally, IC chip 92 may be coupled to copper circuitry bonded to chip-side outermost layer 120A in a conventional manner, e.g., via ball grid array 140 and epoxy 142.

The method and structure as described above are used in the fabrication of packaged integrated circuit chips. The resulting packaged integrated circuit chips can be distributed by the fabricator in panel form (that is, as a single substrate panel that has multiple unpackaged chips), a as a single substrate mounted bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to a person skilled in the art are intended to be included within the scope of the disclosure as defined by the accompanying claims.

What is claimed is:

1. A method comprising:
forming a glass fiber reinforced epoxy core;
forming a plurality of copper circuitry containing particle reinforced epoxy layers symmetrically to each surface of the glass fiber reinforced epoxy core;
forming an outermost glass fiber reinforced epoxy layer on each surface of the plurality of layers; and
mounting an IC chip to copper circuitry bonded to one of the outermost glass fiber reinforced epoxy layers.

2. The method of claim 1, wherein a coefficient of thermal expansion (CTE) of the outermost glass fiber reinforced epoxy layer is approximately 16 to 18 parts per million per degree Celsius (ppm/° C.) below a glass transition temperature of an epoxy matrix of glass fiber reinforced epoxy core 102, and approximately 8-16 ppm/° C. above the glass transition temperature of the epoxy matrix.

3. The method of claim 2, wherein the IC chip has a CTE of approximately 3 ppm/° C.

4. The method of claim 1, wherein the outermost glass fiber reinforced epoxy layer forming includes laminating the outermost layer to the plurality of layers using pressure and thermal curing.

5. The method of claim 1, wherein the outermost glass fiber reinforced epoxy layer forming includes pre-curing the outermost layer and bonding the outermost layer to the plurality of layers using pressure, heat and an adhesive layer.

6. An integrated circuit (IC) chip package comprising:
an IC chip; and
a substrate coupled to the IC chip, the substrate including a glass fiber reinforced epoxy core, a plurality copper circuitry containing, particle reinforced epoxy layers symmetrically-oriented to each surface of the glass fiber reinforced epoxy core, and an outermost glass fiber reinforced epoxy layer on each surface of the plurality of layers,
wherein the IC chip is coupled to copper circuitry bonded to one of the outermost glass fiber reinforced epoxy layer.

7. The IC chip package of claim 6, a coefficient of thermal expansion (CTE) of the outermost glass fiber reinforced epoxy layer is approximately 16 to 18 parts per million per degree Celsius (ppm/° C.) below a glass transition temperature of an epoxy matrix of glass fiber reinforced epoxy core 102, and approximately 8-16 ppm/° C. above the glass transition temperature of the epoxy matrix.

8. The IC chip package of claim 7, wherein the IC chip has a CTE of approximately 3} ppm/° C.

9. The IC chip package of claim 6, further comprising an adhesive layer between the outermost glass fiber reinforced epoxy layer and the plurality of layers.
